(19) United States
(12) Patent Application Publication
(10) Pub. No.: US 2023/0110041 A1
(43) Pub. Date: Apr. 13, 2023

(54) DISASTER RESTORATION PLAN GENERATION APPARATUS, DISASTER RESTORATION PLAN GENERATION METHOD AND PROGRAM

(71) Applicant: NIPPON TELEGRAPH AND TELEPHONE CORPORATION, Tokyo (JP)

(72) Inventors: Zhao WANG, Tokyo (JP); Yusuke NAKANO, Tokyo (JP); Keishiro WATANABE, Tokyo (JP); Ken NISHIMATSU, Tokyo (JP)

(21) Appl. No.: 17/906,502

(22) PCT Filed: Apr. 7, 2020
(86) PCT No.: PCT/JP2020/015681

§ 371 Date: Sep. 16, 2022

(51) Int. Cl. G06N 3/092; G06N 3/045; G06F 18/21

(52) U.S. Cl. CPC G06N 3/092; G06N 3/045; G06F 18/217

(57) ABSTRACT

A disaster recovery plan producing device produces a disaster recovery plan for at least one geographically dispersed location and includes an embedding unit which calculates, using a neural network, a feature quantity for each of the locations from input data including at least position information and a priority about the location, a plan producing unit which determines, using a neural network, an order for performing disaster recovery to the at least one location as a disaster recovery plan on the basis of the feature quantity, and a reinforcement learning unit which learns parameters of the neural network which constitutes the embedding unit and parameters of the neural network which constitutes the plan producing unit by reinforcement learning.

### TECHNICAL FIELD

The present invention relates to techniques for producing disaster recovery plans for a plurality of disaster affected locations.

### BACKGROUND ART

Communication services are provided by a plurality of geographically dispersed communication stations. Herein, the term “communication station” may include a data center or a base station as well as a building provided with a communication device (a communication building).

When a large-scale disaster such as an earthquake occurs, many communication stations may become unable to supply power to communication devices due to power failures, and communication services may be suspended. Even if these stations are provided with batteries or generators, communication services cannot be continued for a long time once the fuel runs out. Access lines to access users may be disconnected, and communication services to the access users may become unavailable.

Therefore, when a disaster occurs, workers have to visit locations stricken by the disaster and carry out recovery work as soon as possible. However, since human and material resources are limited, it is necessary to create an appropriate disaster recovery plan and perform the disaster recovery work for example in order from locations with higher priorities.

NPL 1 as a related art describes a solution to a VRP (Vehicle Routing Problem) by an approach based on reinforcement learning. The Vehicle Routing Problem is the problem of satisfying all the demands and minimizing the total route cost when multiple service vehicles travel from the starting point to the goal point while visiting locations where there is a demand.

NPL 2 describes a general-purpose tool for solving a TSP (Traveling Salesman Problem) or a VRP.

### Citation List

### Non Patent Literature

[NPL 1] Nazari, Mohammadreza, et al. “Reinforcement learning for solving the vehicle routing problem,” Advances in Neural Information Processing Systems, 2018

[NPL 2] Google OR-Tools, google optimization tools, 2016, <URL https://developers.google.com/optimization/routing>

### SUMMARY OF THE INVENTION

### Technical Problem

However, no conventional technique has been suggested to produce a disaster recovery plan for locations such as communication stations which provide communication services after a large-scale disaster. More specifically, NPL 1 and NPL 2 relate only to a VRP or TSP as a simple problem, and a disaster recovery plan which must take into account various factors such as recovery priorities cannot be produced according to their disclosures.

With the foregoing in view, it is an object of the present invention to provide a technique for producing a disaster recovery plan for at least one geographically dispersed location. [Means for Solving the Problem]

According to the disclosed technique, a disaster recovery plan producing device which produces a disaster recovery plan for at least one geographically dispersed location is provided, and the device includes an embedding unit which calculates, using a neural network, a feature quantity for each of the locations from input data including at least position information and priorities about the locations, a plan producing unit which determines, using a neural network, an order for carrying out disaster recovery to the at least one location as a disaster recovery plan on the basis of the feature quantity, and a reinforcement learning unit which learns, by reinforcement learning, parameters of the neural network which constitutes the embedding unit and parameters of the neural network which constitutes the plan producing unit.

### Effects of the Invention

According to the disclosure, a technique for producing a disaster recovery plan for at least one geographically dispersed location is provided.

### BRIEF DESCRIPTION OF DRAWINGS

FIG. 1 illustrates an exemplary situation at the time of a disaster according to an embodiment of the present invention.

FIG. 2 illustrates an exemplary situation at the time of a disaster according to the embodiment.

FIG. 3 is a diagram of a configuration of a disaster addressing plan producing device according to the embodiment.

FIG. 4 is a diagram of a configuration of a disaster addressing plan producing device according to the embodiment.

FIG. 5 is a diagram of a configuration of a disaster addressing plan producing device according to the embodiment.

FIG. 6 is a diagram of a configuration of a disaster addressing plan producing device according to the embodiment.

FIG. 7 is an exemplary hardware configuration of a disaster addressing plan producing device.

FIG. 8 is a diagram of an embedding unit and a conventional encoder (Seq2Seq) in comparison.

FIG. 9 is a diagram for illustrating a sequence unit 212.

FIG. 10 is a diagram of an exemplary pseudocode.

FIG. 11 is a flowchart for illustrating the operation of a disaster addressing plan producing device.

### DESCRIPTION OF EMBODIMENTS

Hereinafter, an embodiment of the present invention will be described with the reference to the drawings. The following embodiment is only an example, and embodiments to which the present invention is applied are not limited to the following embodiment.

The following embodiment relates to a communication station for providing communication services and a recovery plan producing device for example for a disaster stricken access line, but the invention is not limited by the above. For example, the present invention can also be applied to the case of producing a disaster recovery plan for example for locations for providing electricity services, gas services, and water supply.

The communication stations, affected access users, broken parts of access lines, and broken parts of relay lines may be collectively referred to as “locations.”

### Summary of Embodiments

When a large-scale disaster such as an earthquake occurs, communication stations which provide communication services are often damaged. As described above, according to the embodiment, the “communication stations” may include data centers and base stations in addition to buildings having communication devices (communication buildings). Communication stations may suffer physical damage such as collapses or damage to the communication devices or may suffer damage due to power failures which prevent supply of power to the communication devices.

Communication stations (especially the buildings of telecommunication carriers) are provided with batteries. In addition, the stations are provided with generators which run on fuel so that power can be supplied to the communication devices even after the batteries run out. When the fuel runs out, the power cannot be supplied to the communication devices, and the communication service must stop.

Therefore, when a large-scale disaster such as an earthquake occurs and the power goes out, workers need to visit the communication stations and refuel as soon as possible. However, when a power failure occurs in a large area, the number of communication stations that need to be refueled increases, and the workers have to refuel the stations in order. Meanwhile, when the workers visit multiple geographically dispersed communication stations from the location where the workers engaged in refueling are stationed, the workers may refuel less urgent communication stations before refueling more urgent ones without proper planning, and communication services may be kept unavailable for a prolonged period of time as a result.

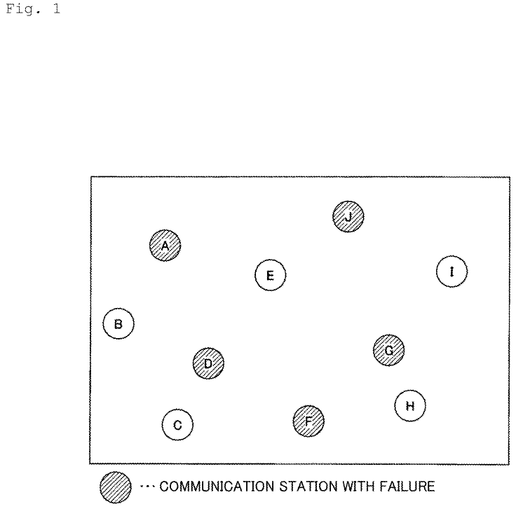

For example, assume that among multiple communication stations A to J dispersed in a geographical area, communication stations A, D, F, G, and J have a failure such as a power failure as shown in FIG. 1. Among these stations, the communication station A has a relay device which relays a large amount of communication traffic, and if the service of communication station A is interrupted, the communication service for an enormous number of users will be stopped.

Meanwhile, although the communication station G has a power failure, the number of users taken care of by the station is small, and the station has sufficient fuel reserves to continue communication services even after a long power failure.

Assume that the worker in charge of refueling is stationed near the communication station G, and the worker decides to refuel in order of proximity to the location of the worker. In this case, refueling for the communication station G, which is less urgent, will be carried out before refueling for the communication station A, which is more urgent, refueling for the communication station A may be delayed as a result, and communication services for an enormous number of users may be stopped.

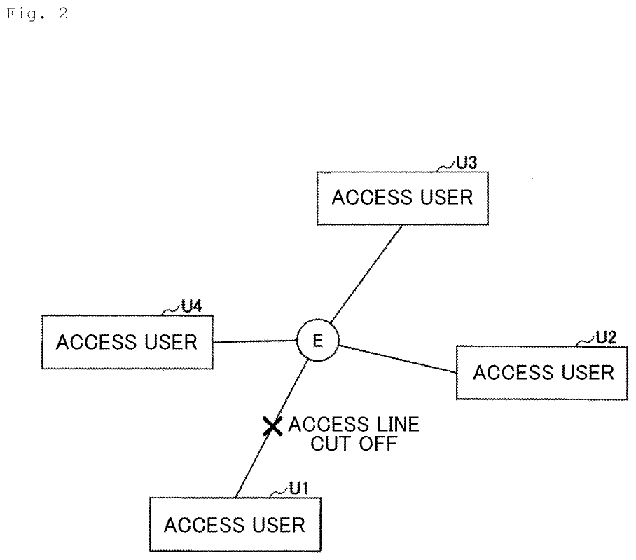

When a large-scale disaster occurs, an access line (such as an optical fiber) connecting a communication station and an access user (a user location) is cut off, and communication service to the access user is stopped. For example, as shown in FIG. 2, if the communication station F is not damaged but the access line between the communication station E and the access user U1 is cut off, the communication service to the access user U1 will be stopped. In such a case, it is necessary for the worker visit the site to repair the access line. Especially in important facilities such as hospitals and police stations, such failures must be recovered as soon as possible. Therefore, an appropriate recovery plan must be made, and the recovery must be carried out accordingly. The same applies to damage caused to relay lines connecting communication stations.

It is difficult for a person to create an appropriate disaster recovery plan for multiple communication stations/access users affected by a disaster. Therefore, according to the embodiment, the disaster recovery plan producing device 100 automatically produces a disaster recovery plan. Hereinafter, the configuration and operation of the disaster recovery plan producing device 100 will be described in detail.

(Exemplary Configuration of Disaster Recovery Plan Producing Device 100)

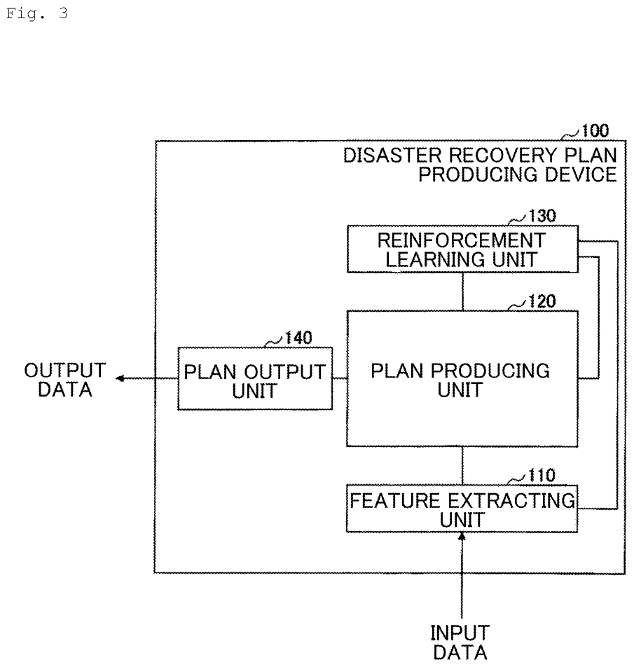

FIG. 3 shows an exemplary configuration of the disaster recovery plan producing device 100 according to the embodiment. As shown in FIG. 3, the disaster recovery plan producing device 100 according to the embodiment includes a feature extracting unit 110, a plan producing unit 120, a reinforcement learning unit 130, and a plan output unit 140. According to the embodiment, the feature extracting unit 110, the plan producing unit 120, and the reinforcement learning unit 130 are each configured using a deep neural network (DNN). However, the use of the DNN is an example, and neural networks other than DNN may be used, or methods other than neural networks may be used.

The feature extracting unit 110 extracts feature quantities from input data. The plan producing unit 120 produces a disaster recovery plan using the feature quantities obtained by the feature extracting unit 110. The plan output unit 140 outputs a disaster recovery plan as output data. The reinforcement learning unit 130 gives a reward to the disaster recovery plan produced by the plan producing unit 120 and updates the parameters of the DNNs of the feature extracting unit 110, the plan producing unit 120, and the reinforcement learning unit 130 on the basis of the reward.

According to the embodiment, an Actor-Critic method is used as a reinforcement learning method. According to the Actor-Critic method, policy evaluation and policy improvement taken care of by an agent in reinforcement learning are separated and modeled individually. The part that is responsible for policy improvement is called Actor, and the part that is responsible for policy evaluation is called Critic.

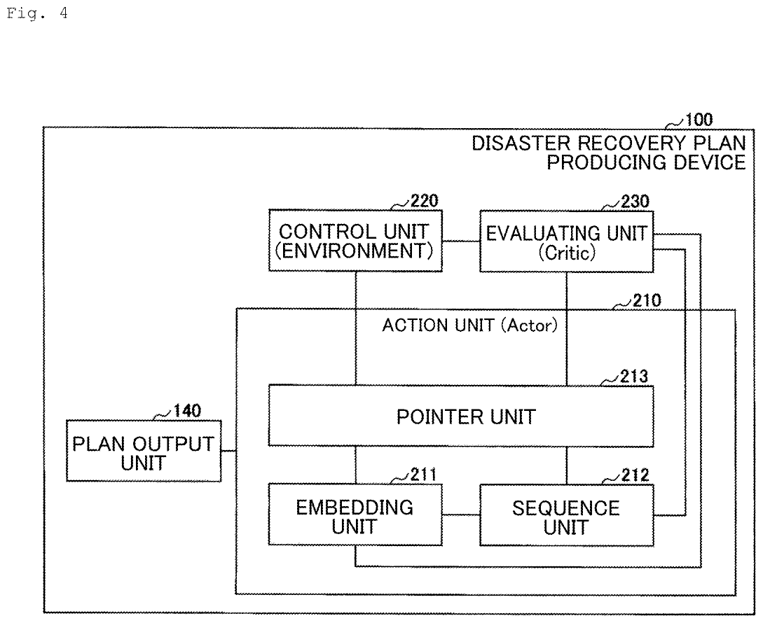

FIG. 4 is a diagram of the configuration of the disaster recovery plan producing device 100 from the viewpoint of the Actor-Critic method.

As shown in FIG. 4, the disaster recovery plan producing device 100 includes an action unit 210 corresponding to the Actor, a control unit 220, and an evaluating unit 230 corresponding to the Critic. The action unit 210 has an embedding unit 211, a sequence unit 212, and a pointer unit 213. The embedding unit 211, the sequence unit 212, and the pointer unit 213 are each configured with a DNN. The evaluating unit 230 is also configured with a DNN. The control unit 220 may be configured with a DNN, or may be configured by methods other than a DNN. The operation of each unit will be described in the following.

The embedding unit 211 in FIG. 4 corresponds to the feature extracting unit 110 in

FIG. 3, the “pointer unit 213 and the sequence unit 212” in FIG. 4 correspond to the plan producing unit 120 in FIG. 3, and the “control unit 220 and the evaluating unit 230” in FIG. 4 correspond to the reinforcement learning unit 130 in FIG. 3.

There is an existing technique called sequence-to-sequence (Seq2Seq), which is used for example for natural language processing. The action unit 210 according to the embodiment differs from the existing technique in that the action unit has the embedding unit (an embedding layer), the sequence unit (a sequence layer), and the pointer unit (a pointer network), and therefore this configuration may be called “Embedding2Seq with Pointer Network.”

According to the embodiment, the disaster recovery plan producing device 100 can perform reinforcement learning by the Actor-Critic method to improve the performance while producing an actual disaster recovery plan at the same time. However, after performing reinforcement learning by the Actor-Critic method using sample data, the disaster recovery plan may be produced using the learned parameters instead of performing reinforcement learning at the same time.

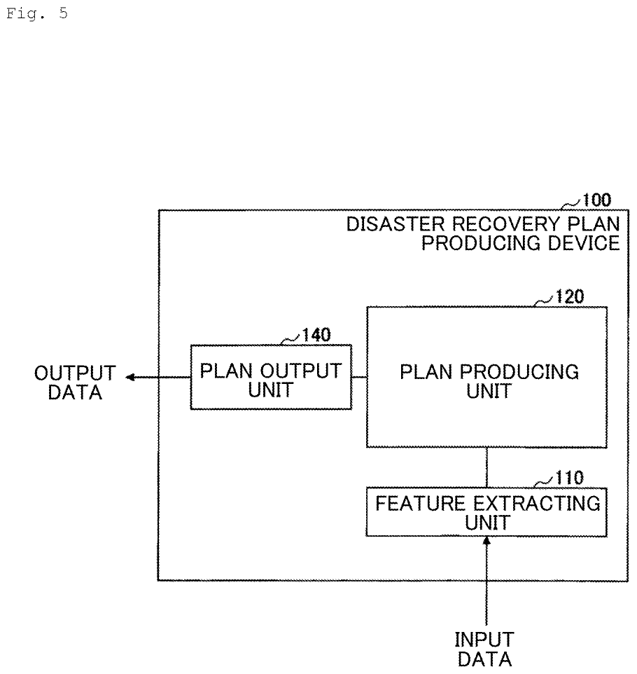

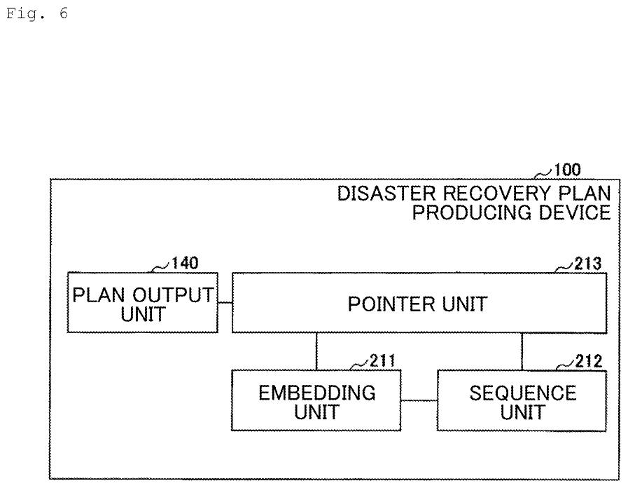

Examples of the disaster recovery plan producing device 100 when a disaster recovery plan is produced using learned parameters are shown in FIGS. 5 and 6. The configuration shown in FIG. 5 corresponds to the configuration shown in FIG. 3 and does not have the reinforcement learning unit 130 shown in FIG. 3. The configuration shown in FIG. 6 corresponds to the configuration shown in FIG. 4 and does not have the control unit 220 and the evaluating unit 230 shown in FIG. 4. The operation of the disaster recovery plan producing devices 100 shown in FIGS. 5 and 6 is the same as the operation of producing a disaster recovery plan in operation performed by the disaster recovery plan producing devices 100 shown in FIGS. 3 and 4.

<Exemplary Hardware Configuration>

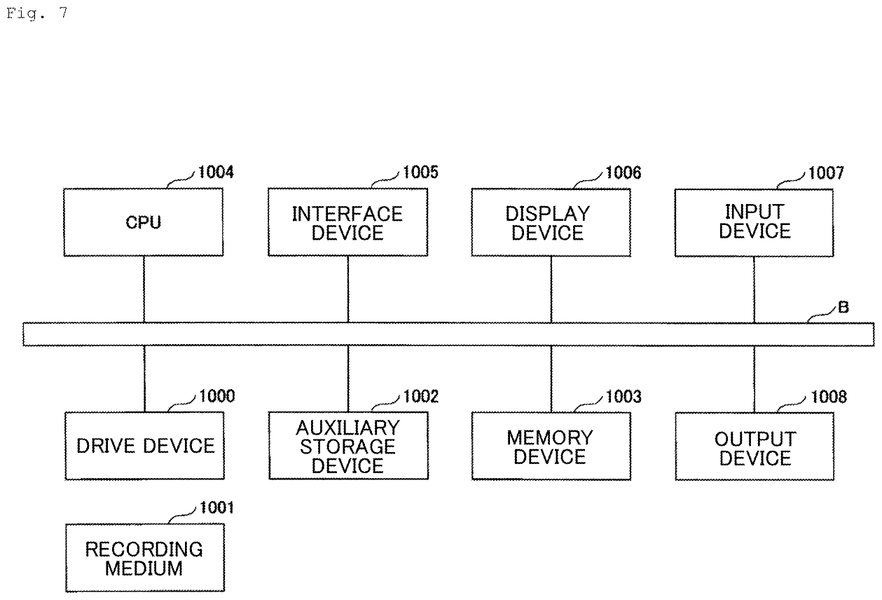

FIG. 7 is a diagram of an exemplary hardware configuration of a computer which can be used as the disaster recovery plan producing device 100 according to an embodiment of the present invention. The computer in FIG. 7 includes a drive device 1000, an auxiliary storage device 1002, a memory device 1003, a CPU 1004, an interface device 1005, a display device 1006, an input device 1007, and an output device 1008 which are interconnected by a bus D. In addition to the CPU 1004, one or more GPUs may be provided.

A program which causes the computer to carry out the processing is provided by a recording medium 1001 such as a CD-ROM and a memory card. When the recording medium 1001 including the program is set in the drive device 1000, the program is installed from the recording medium 1001 to the auxiliary storage device 1002 via the drive device 1000. However, the program does not have to be installed from the recording medium 1001, but may be downloaded from another computer over a network. The auxiliary storage device 1002 stores the installed program and also stores necessary files and data.

The memory device 1003 reads and stores the program from the auxiliary storage device 1002 in response to an instruction to activate the program. The CPU 1004 implements functions related to the disaster recovery plan producing device 100. The interface device 1005 is used as an interface to connect to the network. The display device 1006 displays for example a GUI (Graphical User Interface) by the program. The input device 1007 may include a keyboard and a mouse device, buttons, or a touch panel and is used to input various operating instructions. The output device 1008 outputs calculation results.

(Operation of Each Unit of Disaster Recovery Plan Producing Device 100)

Now, the operation of the disaster recovery plan producing device 100 according to the embodiment will be described. Hereinafter, the operation of the units of the disaster recovery plan producing device 100 according to the embodiment will be described according to the configuration shown in FIG. 4. In the following description, the target of disaster recovery is referred to as the “location.” The “location” may be a communication station, an access user, a damaged part of a relay line, a damaged part of an access line, or something other than the above. However, when “fuel” is used as a feature, it is assumed that the location is a communication station provided with a device (such as a generator) which runs on fuel.

<Embedding Unit 211>

Assume that input data is represented by x ={x₁, x₂, . . . , x_{N}}, where N is an integer greater than or equal to 1. Each xₙ represents a single location.

According to the embodiment, each location has four pieces of information (which may be referred to as features) and is denoted by xₙ={xₙ^{f1}, xₙ^{f2}, xₙ^{f3}, xₙ^{f4}}. xₙ^{f1} is the normalized x-coordinate of the location. xₙ^{f2} is the normalized y-coordinate of the location.

xₙ^{f3} is information indicating the need for fuel at the location or the workload required for recovery at the location. The information indicating the need for fuel at the location is, for example, an actual fuel demand at the location (a communication station). The fuel demand is a value obtained by subtracting the current remaining amount from the maximum capacity of the tank at the location. In addition, Xₙ^{f3} may be the remaining amount of fuel.

xₙ^{f4} represents the priority of the location in recovery. For example, the priority may be indicated by a value from 1 to 10, with smaller values indicating higher priorities.

The above information about each location is an example. The number of pieces of information about each location may be less or more than four.

Each xₙ is input to the embedding unit 211, and the embedding unit 211 embeds (converts) xₙ into a deuce representation. In other words, xₙ is projected to a vector of a higher dimension (a d-dimensional vector). Specifically, x_{n-dense} is obtained using the following Expression 1. The x_{n-dense} may be referred to as the “feature value”.

x_{n-dense} =ω_{embed}·xₙ+b_{embed} (Expression 1)

Here, θ_{embedded}={ω_{embed}, b_{embed}} is a learnable parameter in the embedding unit 211. The embedding unit 211 is implemented, for example, in a fully connected layer or a convolutional layer.

As described above, the Seq2Seq model is one of conventional natural language processing (NPL) neural network models. The Seq2Seq model is a mechanism which receives a sequence (series) as an input and outputs a sequence and includes two LSTMs, Encoder and Decoder.

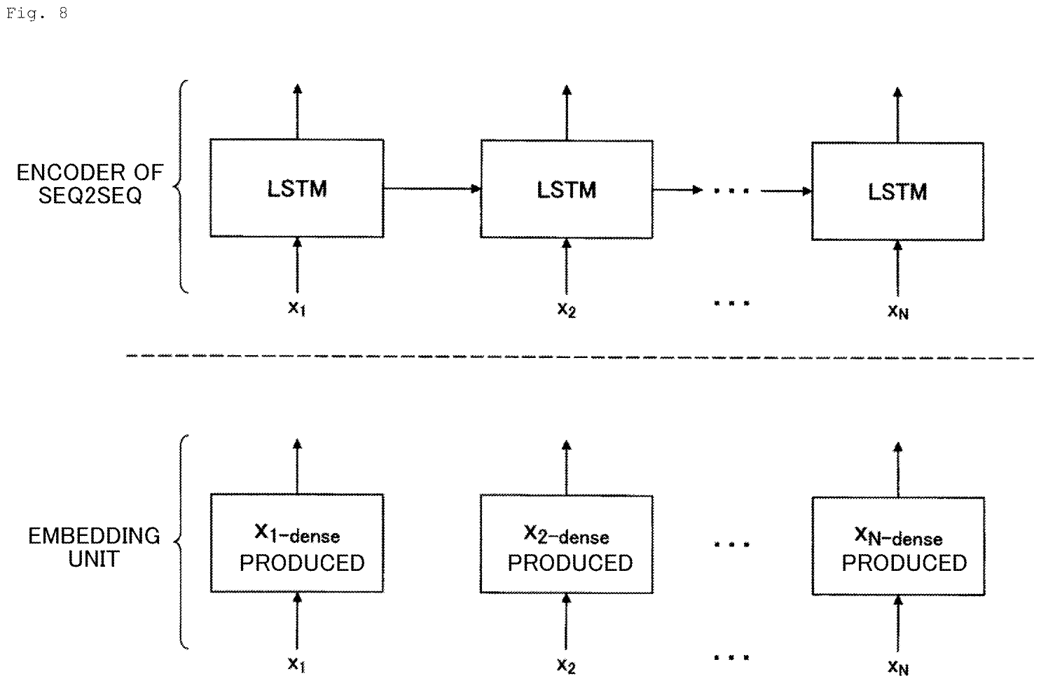

As compared to a conventional NLP neural network model such as the Seq2Seq model, the disaster recovery plan producing device 100 according to the embodiment does not require order information about input data and therefore does not use a recurrent neural network such as an LSTM for the part corresponding to the Encoder but instead uses a fully connected layer or a convolutional layer as described above. FIG. 8 shows the difference between the Encoder of the Seq2Seq and the embedding unit 211.

The disaster recovery plan is output independently of the input order of affected locations. In other words, the same disaster recovery plan is output no matter how the input order of the affected locations is changed.

<Sequence Unit 212, Pointer Unit 213, Plan Output Unit 140>

After embedding all inputs χ={x₁, x₂, . . . , x_{N}} into χ_{dense}={x_{1-dense}, x_{2-dense}, . . . , x_{N-dense}}, the sequence unit 212 and the pointer unit 213 generate a disaster recovery plan. The disaster recovery plan according to the embodiment is the order of recovery of the elements (locations) of χ. For example, if the order “x₄, x₂, x₁, and x₃” is obtained as the disaster recovery plan when information about four locations is input as input data (i.e., when N=4), which means a disaster recovery plan indicating that the worker will visit the locations x₄, x₂, x₁, and x₃ in this order for recovery work (such as refueling) has been created.

The sequence unit 212 is configured with a recurrent neural network. According to the embodiment, an LSTM (Long short-term memory) is used as the recurrent neural network. In general, the LSTM outputs a hidden state hₜ (which may be referred to as the intermediate state) for the input xₜ at time t, and at time t+1, the hidden state hₜ and an input xₜ₊₁ are input and a hidden state hₜ₊₁ is output.

According to the embodiment, as sampling by a Monte Carlo method, the sequence unit 212 and the pointer unit 213 perform M decoding steps (M is an integer greater than or equal to 1). The hidden state output by the LSTM in step m (m ∈(1, 2, . . . , M)) is denoted as dₘ.

The pointer unit 213 calculates which location among the locations x={x₁, x₂, . . . , x_{N}} is pointed (specified) on the basis of χ_{dense}={χ_{1-dense}, x_{2-dense}, x_{N-dense}} produced by the embedding unit 211 and the hidden state dₘ of the sequence unit 212 (LSTM), which will be more specifically described in the following.

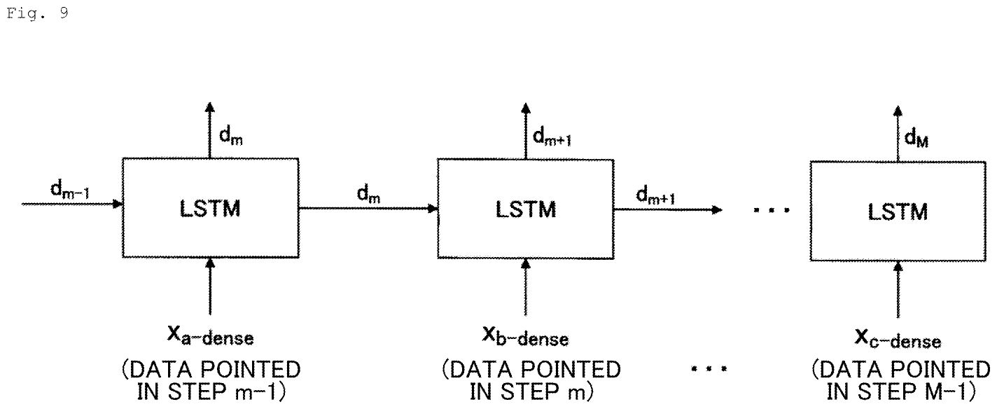

FIG. 9 shows the operation of the LSTM (sequence unit 212) on the time series. As shown in FIG. 9, in step m, the hidden state dₘ₋₁ in step m-1 is input to the LSTM, and the x_{a-dense} specified (pointed) by the point unit 213 in step m-1 is input. Similarly, in step m+1, the hidden state dₘ in step m is input to the LSTM and the X_{b-dense} selected by the point unit 213 in step m is input. The same applies thereafter.

The pointer unit 213 calculates p(Dₘ|D₁, D₂, . . . , Dₘ₋₁, χ; θ) according to the following Expressions (2) and (3). Dₘ indicates which location in χ={x₁, x₂, . . . , x_{N}} has been selected in step m. In other words, Dₘ indicates which location has been selected as the next location to be visited for disaster recovery.

p(Dₘ|D₁, D₂, . . . , Dₘ₋₁, χ; θ) is the order obtained up to step m-1, under the parameter θ (D₁, D₂, . . . , Dₘ₋₁) and is the probability distribution of χ={x₁, x₂, . . . , x_{N}} under the condition the input χ of In other words, it shows the probability distribution corresponding to which location is to be specified next.

If N=4(χ={x₁, x₂, x₃, x₄}), then p(Dₘ|D₁, D₂, . . . , Dₘ₋₁, χ; θ) for example indicates that the probability of x₁=0.1, the probability of x₂=0.1, the probability of x₃=0.7, and the probability of x₄=0.1.

uₙ^{m}=v^{T}tanh (W₁x_{n-dense}+W₂dₘ) , n-dense ∈ (1,2, . . . , N) (Expression 2)

p(Dₘ|D₁, D₂, . . . , Dₘ₋₁, χ; θ)=softmax (u^{m}) (Expression 3)

In Expression 2, v is a d-dimensional vector, and W₁ and W₂ are d×d matrices. However, these dimension numbers are an example. As shown in Expression 3, the softmax function normalizes the vector u^{m} (an N-dimensional vector) and outputs a probability distribution for each location in the input χ. θ={v, W₁, W₂} holds, where θ is the learnable parameter of the pointer unit 213.

The plan output unit 140 outputs a result obtained by the pointer unit 213. For example, the plan output unit 140 outputs the order of the obtained locations after the completion of steps 1 to M. Note that M is a value greater than or equal to N. However, M is not limited to a value greater than or equal to N.

<Control Unit 220 and Evaluating Unit 230>

The control unit 220 and the evaluating unit 230 perform reinforcement learning of the disaster recovery plan producing device 100. As described above, according to the embodiment, reinforcement learning is performed by the Actor-Critic method. The action unit 210 or the “embedding unit 211, the sequence unit 212, and the pointer unit 213” in the configuration of the disaster recovery plan producing device 100 shown in FIG. 4 correspond to the Actor. The evaluating unit 230 corresponds to the Critic.

According to the embodiment, a policy n (a stochastic policy) is represented as a parameter (θ_{actor}) in the Actor (the “embedding unit 211, the sequence unit 212, and the pointer unit 213”).

Specifically, θ_{actor}, includes θ_{embedded}, θ_{LSTM}, and θ. θ_{embedded} is a learnable parameter in the embedding unit 211, where θ_{embedded}={ω_{embed}, b_{embed}} θ_{LSTM} is a learnable parameter for the sequence unit 212 (the LSTM according to the embodiment). θ is a learnable parameter for the pointer unit 213, where θ={v, W₁, W₂}.

As described above, the action unit 210 (Actor) produces p(Dₘ|D₁, D₂, . . . , Dₘ₋₁, χ; θ) in each step m and determines Dₘ accordingly.

The evaluating unit 230, which corresponds to the Critic, is a model using a neural network (such as a DNN), and the learnable parameter of the model is θ_{critic}. The evaluating unit 230 estimates a reward according to the disaster recovery plan (D₁, D₂, D_{M-1}, D_{M}) calculated by the action unit 210. Here, the reward estimated by the evaluating unit 230 is denoted as V(Dₘ; θ_{critic}).

For example, the evaluating unit 230 calculates a weighted sum for the action value (Dₘ) obtained on the basis of the probability distribution p(Dₘ|D₁, D₂, . . . , Dₘ₋₁, χ; θ) to obtain a single value. The weight of the weighted sum is a learnable parameter θ_{critic}.

For example, if M=4 (m ∈ {1, 2, 3, 4}), and D₁=x_{2-dense}, D₂=x_{1-dense}, D₃=x_{4-dense}, and D₄=x_{3-dense}, then V (Dₘ; θ_{critic})=α·x_{1-dense}+β·x_{2-dense}+γ·x_{3-dense}+η·x_{4-dense}. α, β, γ, and η are the weights. This is an example, and V(Dₘ; θ_{critic}) may be calculated in any other method.

The control unit 220 controls reinforcement learning by a policy gradient method.

Specifically, the control unit 220 calculates a reward R on the basis of an action sequence (D₁, D₂, . . . , D_{M-1}, D_{M}), calculates the reward R and the policy gradients (dθ_{actor}, dθ_{critic}), and updates the parameter θ_{actor} of Actor and the parameter θ_{critic} of Critic using the policy gradients (dθ_{actor}, dθ_{critic}). The parameter θ_{actor} of Actor is updated so that the reward obtained becomes larger, and the parameter θ_{critic} of Critic is updated so that the difference between R and V(Dₘ; θ_{critic}) is reduced.

(Example of Operation Procedure)

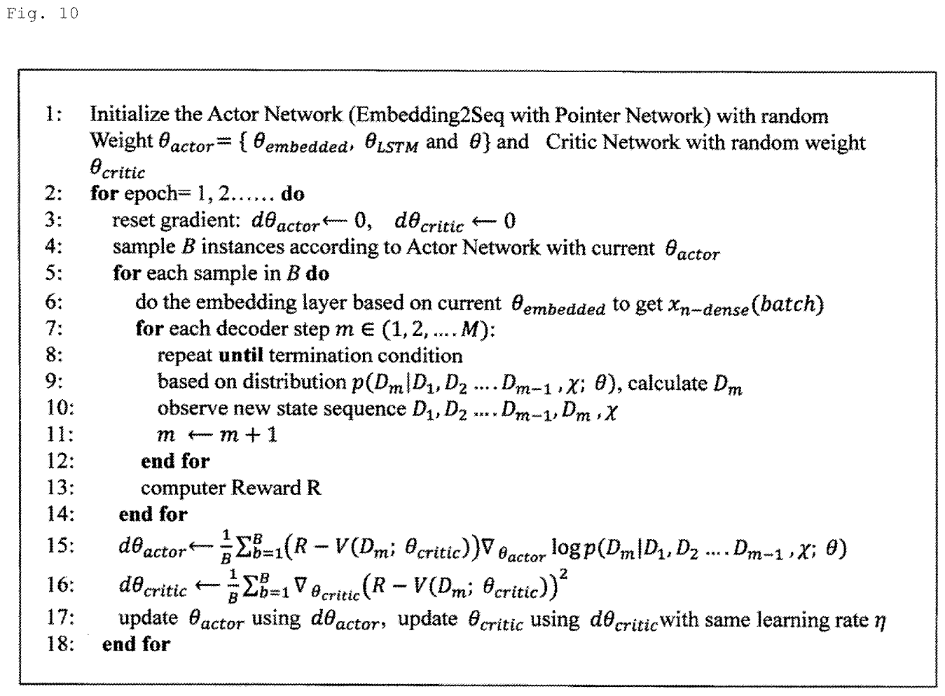

FIG. 10 shows an exemplary processing algorithm for performing reinforcement learning using the Actor-Critic method.

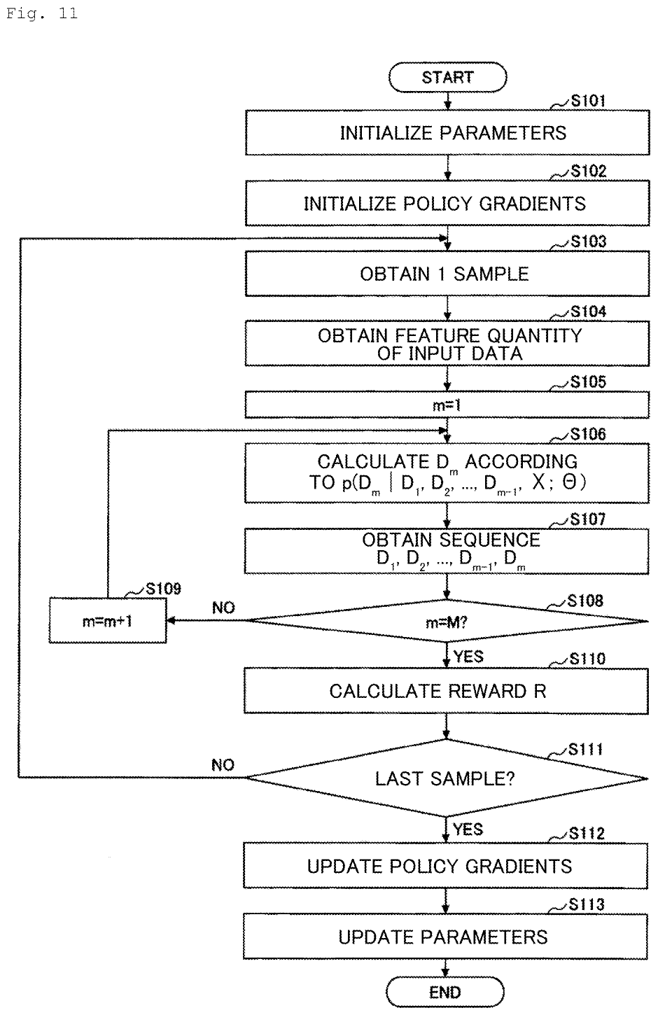

An example of the operation of the disaster recovery plan producing device 100 according to the algorithm shown in FIG. 10 will be described in conjunction with the procedure in the flowchart in FIG. 11. FIG. 11 shows the operation of one epoch in FIG. 10. In this case, D samples are used. In each of the B samples, a sequence (order) as a sequence of results of actions on input data is obtained. After the end of the processing to the B samples, the parameters are updated. During the processing to the B samples, the parameters are not updated.

In S101, the control unit 220 initializes the parameter θ_{actor}={θ_{embedded}, θ_{LSTM}, θ} of the action unit 210 (Actor) and the parameter θ_{critic} of the evaluating unit 230 (Critic) with random weights.

In S102, the control unit 220 initializes each of the policy gradients dθ_{actor} and dθ_{critic} to zero.

In S103, the control unit 220 obtains one unprocessed sample (χ={x₁, x₂, . . . , x_{N}}) from the B samples. In S104, χ={x₁, x₂, . . . , x_{N}} is input to the embedding unit 211, and the embedding unit 211 calculates χ_{dense}={x_{1-dense}, x_{2-dense}, . . . , x_{N-dense}}.

According to the embodiment, M decoding steps are performed. First, in 3105, the control unit 220 sets m=1.

In S106, the pointer unit 213 calculates p(Dₘ|D₁, D₂, . . . , Dₘ₋₁, χ; θ) and obtains Dₘ on the basis of p(Dₘ|D₁, D₂, . . . , Dₘ₋₁, χ; θ). For example, the one with the highest probability among χ={x₁, x₂, . . . , x_{N}} is determined as Dₘ. The value of Dₘ may be the identifier of the location (the subscript “n” if the determined one is xₙ), x_{n-dense}, or any other value which can identify the location.

In S107, the sequence D₁, D₂, . . . , Dₘ₋₁, Dₘ is obtained by action values obtained up to the point (though when m=1, no value is obtained up to the point). The sequence D₁, D₂, . . . , Dₘ₋₁, Dₘ and p(Dₘ|D₁, D₂, . . . , Dₘ₋₁, χ; θ) corresponding thereto are stored in storage means such as the memory of the control unit 220 and can be referred to by the plan output unit 140, the control unit 220, and the evaluating unit 230.

In S108, the control unit 220 determines whether m=M. If m=M does not hold, the process proceeds to S109 and repeats the processing from S106 by setting m=m+1.

In S108, if m=M holds, the control unit 220 gives the reward R on the basis of the obtained sequence D₁, D₂, . . . , D_{M-1}, D_{M} in S110.

In an algorithm such as Actor-Critic, learning proceeds such that the reward R calculated by the result of the action is increased. The method for calculating the reward R according to the embodiment is not limited to a specific method, and for example, the control unit 220 gives the distance traveled by the worker to the location for recovery as the reward R. However, as the distance to be traveled (traveled distance) is smaller, the result is better, and therefore, in this case, the reward R is given by “−1×travel distance.”

The distance traveled is, for example, the distance traveled by the worker in the order “the location 1, the location 2, and the location 3” when the action value column goes like “the location 1, the location 2, and the location 3.” If the starting point for the worker is the point S, the distance traveled may be the distance traveled from “the point S to the location 1, the location 2, and to the location 3.”

The priority included as information in the input data χ may be reflected in the reward R. For example, the reward R may be determined according to the number of pairs of locations for which the given priority and the actual order are switched. In addition, the distance traveled and priority may be comprehensively taken into account by weighting.

For example, if the traveled distance is “−L”, its weight is W_{L}, the punishment due to priority violation is “−P” and its weight is W_{P}, R=W_{L}×(−L)+W_{P}×(−P) results.

The service continuity may also be reflected in the reward R. For example, the time between the worker's departure and arrival at each location is calculated on the basis of the worker's travel speed and distance and the time spent working at the locations through which the worker travels, then the service duration is calculated on the basis of the amount of fuel remaining at each location on the basis of the worker's travelling speed, and the reward R may be determined according to the number of locations where “service duration<time until arrival.”

In addition, the traveled distance, the priority, and the service continuity may be comprehensively considered by weighting. For example, if the traveled distance is “−L” and its weight is W_{L}, the punishment for violation of priority is “−P” and its weight is Wp, the punishment for violation of service continuity (“service duration <time until arrival”) is “−S” and its weight is Wₛ, R=W_{L}×(−L)+W_{P}×(−P)+W_{S}×(−S) results.

The control unit 220 may determine the reward R on the basis of at least one of the distance traveled by the worker between locations according to the disaster recovery plan, the consistency between the order of recovering locations in the disaster recovery plan and the priorities of the locations in input data, and the service continuity at the locations.

In S111 in the flow in FIG. 11, the control unit 220 determines whether all of the B samples have been processed. If there are still unprocessed samples (No in S111), the process returns to S103 and repeats the processing with another sample. If all of the B samples have been processed, the process proceeds to S112.

In S112, the control unit 220 calculates policy gradients using the following Expression shown in lines 15 and 16 in FIG. 10. Note that updating the policy gradients with the following expression itself is publicly known, for example, as shown in “Algorithm 3 REINFORCE Algorithm” in NPL 1.

dθ_{actor}<−(1/B) Σ^{B}_{b=1}(R-V (Dₘ; θ_{critic})) ∇_{θactor}log p (Dₘ|D₁, D₂, . . . , Dₘ₋₁, χ; θ)

dθ_{critic}<−(1/B) Σ^{B}_{b=1}∇_{θcritic} (R-V (Dₘ; θ_{critic})) ²

In S113, the control unit 220 updates θ_{actor} and θ_{critic} with the same learning rate using dθ_{actor} and dθ_{critic} calculated in S112, respectively.

### Effects of Embodiment

According to the embodiment, information about affected locations is input to the disaster recovery planning device 100, so that a disaster recovery plan for example according to the priority of the locations can be obtained, and disaster recovery can be performed more quickly and efficiently.

Also according to the embodiment, since parameters are learned by reinforcement learning, recovery plans for large-scale disasters with a little training data can be efficiently learned.

### Summary of Embodiments

Herein, at least a disaster recovery plan producing device, a disaster recovery plan producing method, and a program are disclosed in the following items.

### (Item 1)

A disaster recovery plan producing device which produces a disaster recovery plan for at least one geographically dispersed location, the device comprising:

an embedding unit which calculates, using a neural network, a feature quantity for each of the locations from input data including at least position information and a priority about the location;

a plan producing unit which determines, using a neural network, an order for carrying out disaster recovery to the at least one location as a disaster recovery plan on the basis of the feature quantity; and

a reinforcement learning unit which learns, by reinforcement learning, parameters of the neural network which constitutes the embedding unit and parameters of the neural network which constitutes the plan producing unit.

### (Item 2)

The disaster recovery plan producing device according to item 1, wherein each of the locations has equipment with a demand, and the input data includes the demand for each of the locations.

### (Item 3)

The disaster recovery plan producing device according to item 1 or 2, wherein the plan producing unit comprises:

a sequence unit configured with a recurrent neural network having a hidden state; and

a pointer unit which specifies locations for disaster recovery in order on the basis of the feature quantity and the hidden state.

### (Item 4)

The disaster recovery plan producing device according to any one of items 1 to 3, wherein the reinforcement learning is reinforcement learning according to an actor-critic method,

the reinforcement leaning unit comprises a control unit and an evaluating unit configured with a neural network,

the control unit updates parameters of the embedding unit and the plan producing unit which function as an actor and parameters of the evaluating unit which functions as a critic on the basis of a reward given to the disaster recovery plan produced by the plan producing unit.

### (Item 5)

The disaster recovery plan producing device according to item 4, wherein the control unit determines the reward on the basis of at least one of a distance traveled by a worker between locations according to the disaster recovery plan, consistency between an order for recovering the locations in the disaster recovery plan and priorities for the locations in the input data, and service continuity in the locations.

### (Item 6)

A disaster recovery plan producing device which produces a disaster recovery plan for at least one geographically dispersed location, the device comprising:

an embedding unit which calculates, using a neural network, a feature quantity for each of the locations from input data including at least position information and a priority about the location;

a sequence unit configured with a recurrent neural network having a hidden state; and a pointer unit which produces a disaster recovery plan by specifying locations to be subjected to disaster recovery in order on the basis of the feature quantities and the hidden states.

### (Item 7)

A disaster recovery plan producing method carried out by a disaster recovery plan producing device which produces a disaster recovery plan for at least one geographically dispersed location, the method comprising:

an embedding step including calculating a feature quantity for each of the locations from input data including at least position information and a priority about the location using a neural network;

a plan producing step including determining an order for carrying out disaster recovery to the at least one location as a disaster recovery plan on the basis of the feature quantity using a neural network; and

a reinforcement learning step including learning parameters of the neural network used in the embedding step and parameters of the neural network used in the plan producing step by reinforcement learning.

(Item 8) A program for causing a computer to function as each unit in the disaster recovery plan producing device according to any one of items 1 to 6.

The embodiments have been described but the present invention is not limited by any of the specific embodiments and various modifications and variations are available within the gist and scope of the present invention recited in the claims.

### REFERENCE SIGNS LIST

100 Disaster recovery plan producing device
110 Feature extracting unit
120 Plan producing unit
130 Reinforcement learning unit
140 Plan output unit
210 Action Unit
211 Embedding Unit
212 Sequence Unit
213 Pointer unit
220 Control Unit
230 Evaluating unit
1000 Drive unit
1001 Recording medium
1002 Auxiliary storage device
1003 Memory device
1004 CPU
1005 Interface device
1006 Display device
1007 Input device

1. A disaster recovery plan producing device which produces a disaster recovery plan for at least one geographically dispersed location, the device comprising:
a processor; and
a memory storing program instructions that cause the processor to:
calculate:, calculate, using a first neural network, a feature quantity for each of the locations from input data including at least position information and a priority about the location;
determines determine, using a second neural network, an order for carrying out disaster recovery to the at least one location as a disaster recovery plan on the basis of the feature quantity; and
learns learn, by reinforcement learning, parameters of the first neural network and parameters of the second neural network.

2. The disaster recovery plan producing device according to claim 1, wherein each of the locations has equipment with a demand, and the input data includes the demand for each of the locations.

3. The disaster recovery plan producing device according to claim 1, wherein
the processor is configured to output, using a recurrent neural network having, a hidden state; and
the processor is configured to specify locations for disaster recovery in order on the basis of the feature quantity and the hidden state.

4. The disaster recovery plan producing device according to claim 1, wherein the reinforcement learning is reinforcement learning according to an actor-critic method,
the processor is configured to update parameters of the first neural network and the second neural network which function as an actor and parameters of a third neural network which functions as a critic on the basis of a reward given to the disaster recovery plan produced by the plan producing unit.

5. The disaster recovery plan producing device according to claim 4, wherein the processor determines the reward on the basis of at least one of a distance traveled by a worker between locations according to the disaster recovery plan, consistency between an order for recovering the locations in the disaster recovery plan and priorities for the locations in the input data, and service continuity in the locations.

6. A disaster recovery plan producing device which produces a disaster recovery plan for at least one geographically dispersed location, the device comprising:
a processor; and
a memory storing program instructions that cause the processor to:
calculate, using a neural network, a feature quantity for each of the locations from input data including at least position information and a priority about the location;
output, using a recurrent neural network, a hidden state; and
produces produce a disaster recovery plan by specifying locations for disaster recovery in order on the basis of the feature quantity and the hidden state.

7. A disaster recovery plan producing method carried out by a disaster recovery plan producing device which produces a disaster recovery plan for at least one geographically dispersed location, the method comprising:
calculating a feature quantity for each of the locations from input data including at least position information and a priority about the location,_{—} using a first neural network;
determining an order for carrying out disaster recovery to the at least one location as a disaster recovery plan on the basis of the feature quantity using a second neural network; and
learning parameters of the first neural network and parameters of the second neural network by reinforcement learning.

8. A non-transitory computer-readable recording medium having stored therein a program for causing a computer to perform the method according to claim 7.
